(19) United States
(12) Patent Application Publication
(10) Pub. No.: US 2021/0136585 A1
(43) Pub. Date: May 6, 2021

(54) Detecting False Cell Towers

(71) Applicant: SECURE MOBILE TECHNOLOGIES AS, 4250 Kopervik (NO)

(72) Inventor: Odd Helge Rosberg, 5570 Aksdal (NO)

(73) Assignee: SECURE MOBILE TECHNOLOGIES AS, 4250 Kopervik (NO)

(21) Appl. No.: 16/492,246

(22) PCT Filed: Mar. 9, 2018
(86) PCT No.: PCT/EP2018/055967

§ 371 Date: Sep. 9, 2019

(30) Foreign Application Priority Data
Mar. 9, 2017 (GB) 1703776.3

(51) Int. Cl. H04W 12/121; H04W 12/63; H04W 24/08; H04W 64/00

(52) U.S. Cl. CPC H04W 12/121; H04W 12/63; H04W 84/042; H04W 64/00; H04W 24/08

(57) ABSTRACT

A method of determining the legitimacy of a base station (20) in a cellular telecommunications network by an electronic communication device (10) capable of connection to the cellular telecommunications network comprises the electronic communication device (10) determining an expected signal strength for transmissions from the base station (20) based at least on an expected geographical location of the base station relative to a current geographical location of the electronic communication device (10). The electronic communication device (10) measures an actual signal strength of transmissions from the base station (20) and compares the actual signal strength to the expected signal strength. The electronic communication device (10) determines that the base station (20) is illegitimate if the actual signal strength exceeds the expected signal strength by at least a predetermined amount.

This invention relates to an apparatus and method for detecting a false cell tower, in particular for detecting an IMSI-catcher.

### BACKGROUND

An International Mobile Subscriber Identity (IMSI) is an identifier for an electronic communications device, such as a mobile phone, which subscribes to a cellular network. For GSM, UTMS and LTE networks, the IMSI number is provided on the SIM card of the electronic communications device. Knowledge of an IMSI number for a particular device can be used by eavesdroppers to identify and track the user of the electronic communications device.

In the world of intelligence and espionage there have long been devices called IMSI-catchers or Stingray units in use. Their purpose has been to harvest the IMSI numbers from an electronic communications device's SIM card by taking over the communication to the device for a brief period. An IMSI-catcher is an electronic device comprising at least a transceiver, the IMSI-catcher typically posing as a cell tower (sometimes called a base transceiver station or simply base station) and mimicking the behaviour of a genuine cell tower without being a part of a legitimate service from a telecommunications company (Telco).

In recent years the cost of IMSI-catchers has decreased significantly. Cheap devices have also emerged that can easily be converted into IMSI-catchers. As such, the usage and scope of applications for IMSI-catchers has grown way beyond the world of lawful interception. IMSI-catchers are now widely used in both industrial espionage and personal espionage. This poses a very real and legitimate threat to users of electronic communications devices on cellular networks. There is therefore a call for a protection system to safeguard users of electronic communications devices against IMSI-catchers.

The behaviours of many IMSI-catchers are illusive. IMSI-catchers can function at the SIM-card and modem level of the device without ever needing to penetrate into the main operating system level of the electronic communications device. The electronic communications devices vulnerable to IMSI-catchers may be an electronic communications device such as a mobile phone, for example a smartphone, or indeed any machine-to-machine (M2M) device that utilizes a cellular network, including machine-to-machine (M2M) devices. In a further example, the electronic communications device may be a personal computer, for example a tablet computer.

Whilst the standard behaviour of the IMSI-catcher is to harvest IMSI numbers to identify and track the mobile subscriber, more advanced IMSI-catchers are able to do a lot more. Primary amongst these additional abilities is the delivery of messages to the device. The messages may be SMS or MMS or any other message implemented under the standard GSM protocol (or other similar mobile protocols). In particular for SMS and MMS, the standards used to send these messages are amongst the oldest in the telecommunications business still in use, and they were not made with the security requirements of the current technology world in mind. There is a set of messages that are called ‘silent SMS’ or ‘service SMS’ (as well as other names) that were originally designed affect the mobile user's device without involving the user. This may be updating the SIM-card, tracking the device, provisioning of the device, remote locking of the device, remote wiping of the memory of the device and other actions. Since the GSM standard itself is relatively old (first put in service in 1985, and later expanded in 1995) there are numerous ways to bypass the security built into the standard which can be exploited by some of the more advanced IMSI-catchers.

In addition to these capabilities, the more advanced IMSI-catchers can also launch different IP-based attacks to bypass the security of the device. One should bear in mind that these attacks are invisible to the device's operating system, as they are directed towards the modem and SIM-card, each typically encompassing a processing unit and operating system of their own. For this reason, no security suite or Enterprise Mobility Management (EMM) system in the operating system is able to detect an attack and subsequent injection of code.

In addition to all this, the modems of the electronic communications devices mostly use remote modem commands, based on the Hayes command set, first used in 1981. There are standard command sets described in the mobile standards, for example GSM. In addition, most manufacturers provide their own additional commands in the command set to achieve custom functionality. This creates additional possibilities for IMSI-catchers when seeking to penetrate the security of the device and introduce malicious software into the device. This software can be placed in the SIM-card or modem layer, where it is invisible from the main device OS, or, in some cases, it can even be placed in the main OS itself.

IMSI-catchers and their functionalities are rapidly developing. This is combined with a significant decrease in the costs of IMSI-catchers. The usage of IMSI-catchers is highly restricted in most countries, but due to their illusive nature they can often be used without being detected.

Telco's have done their utmost to prevent the exploitation of the vulnerabilities relied on by IMSI-catchers, but with only partial success. It is difficult to counter this threat because the IMSI-catcher poses as a valid cell tower from the electronic communications device's perspective.

There have been several attempts to make devices to uncover the usage of IMSI-catchers. The approaches can either be hardware or software based. In the case of software, apps have been developed that run on the Android platform. The approach in both cases is typically to monitor the protocols and technical details of the process of connecting to a cell tower with a view to identifying discrepancies. If discrepancies are identified, these are reported (either to the user or to a central server) as a possible IMSI-catcher attack. However, this approach has proved to be less successful over time as the IMSI-catchers get better and better at emulating the correct protocols and procedures.

The most notable attempts to create such software for Android are SnoopSnitch from Security Research Labs and AIMSICD, an open source project administered by SecUpwN.

The present disclosure seeks to provide at least an alternative to the methods and apparatus for detecting IMSI-catchers found in the prior art. In addition, there are also disclosed herein methods and apparatus for operating after IMSI-catchers have been detected.

### BRIEF SUMMARY OF THE DISCLOSURE

In accordance with the present inventions there is provided a method of determining the legitimacy of a base station in a cellular telecommunications network by an electronic communication device capable of connection to the cellular telecommunications network. The method comprises the electronic communication device determining an expected signal strength for transmissions from the base station based at least on an expected geographical location of the base station relative to a current geographical location of the electronic communication device. The electronic communication device measures an actual signal strength of transmissions from the base station and compares the actual signal strength to the expected signal strength. The electronic communication device determines that the base station is illegitimate if the actual signal strength exceeds the expected signal strength by at least a predetermined amount.

The electronic communication device may receive identification information from the base station. The electronic communication may retrieve data in respect of the base station from a database using the identification information. The electronic communication device may determine that the base station is illegitimate if the retrieved data indicates that the base station is illegitimate, i.e. the base station is on a “red list”. The electronic communication device may determine that the base station is legitimate if the retrieved data indicates that the base station is legitimate, i.e. the base station is on a white list.

The retrieved data may include the expected signal strength for transmissions from the base station at the current geographical location of the electronic communication device, for example from a signal strength map.

The retrieved data may include the expected geographical location of the base station.

The electronic communication device may request the expected geographical location from the base station. The electronic communication device may determine that the base station is illegitimate if the base station does not provide the expected geographical location.

The electronic communication device may determine the expected geographical location of the base station relative to a current geographical location of the electronic communication device based on ping time measurements of communications between the electronic communication device and the base station.

The electronic communication device may calculate the expected signal strength based on the current geographical location of the electronic communication device and the expected geographical location of the base station.

Regardless of signal strength, the electronic communication device may determine that the base station is illegitimate if the distance between the current geographical location of the electronic communication device and the expected geographical location of the base station is greater than a predetermined value.

The electronic communication device may determine that the base station is illegitimate if the actual signal strength exceeds an absolute predetermined value.

The electronic communication device may determine that the base station is illegitimate if the difference between the actual signal strength and a previous measurement of the actual signal strength, if any, at substantially the same current geographical location of the electronic communication device exceeds a predetermined value.

Viewed from a further aspect, the present invention provides a method of determining the legitimacy of a base station in a cellular telecommunications network by an electronic communication device capable of connection to the cellular telecommunications network. The method comprises the electronic communication device determining a distance between an expected geographical location of the base station relative to a current geographical location of the electronic communication device and the electronic communication device determining that the base station is illegitimate if the distance between the current geographical location of the electronic communication device and the expected geographical location of the base station is greater than a predetermined value.

If the electronic communication device determines that the base station is illegitimate, the electronic communication device may send identifying information relating to the illegitimate base station to at least one further electronic communication device. The electronic communication device may send the identifying information to the further electronic communication device via a communications channel other than the cellular telecommunications network, for example via WiFi. On receipt of the identifying information the further electronic communication device may attempt to determine a distance between an actual geographical location of the base station and the current geographical location of the other electronic communication device. Similarly, the electronic communication may attempt to determine a distance between an actual geographical location of the base station and the current geographical location of the other electronic communication device. The method may comprise determining the actual geographical location of the base station on the basis of the distances between the actual geographical location of the base station and the current geographical locations of the electronic communication device and the further electronic communication device.

The invention extends to an electronic communication device configured to carry out the method disclosed herein and to computer software that configures an electronic communication device to carry out the method.

### BRIEF DESCRIPTION OF THE DRAWINGS

Embodiments of the invention are further described hereinafter with reference to the accompanying drawings, in which:

FIG. 1 shows a diagram of an environment for an electronic communications device in accordance with the present disclosure; and

FIG. 2 shows a block diagram illustrating an electronic communications device with a touch-sensitive display which can be used to carry out the methods of the present disclosure.

### DETAILED DESCRIPTION

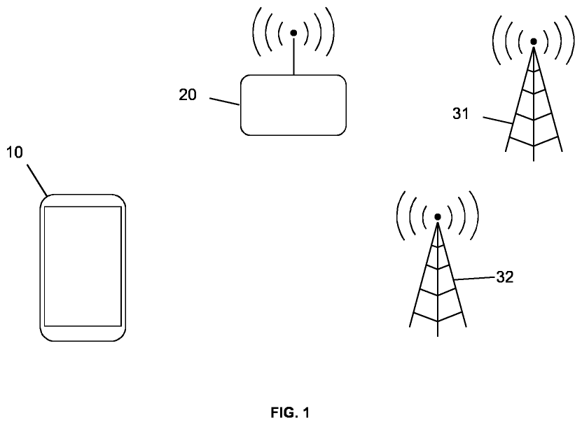

FIG. 1 shows a diagram of an environment for an electronic communications device 10 in accordance with the present disclosure. The electronic communications device 10 is provided with a transceiver (not shown), which allows the electronic communications device 10 to send and receive wireless communications to and from corresponding transceivers within the communication range of the electronic communications device 10. In a cellular network, as represented in FIG. 1, the electronic communications device 10 establishes communication with a base station 31, 32 within the communication range of the electronic communications device 10. The base stations 31, 32 are nodes in the cellular network that are typically interconnected by wired communications links. In order to establish communication with the base station 31, 32 the electronic communications device 10 must make a request to the base station 31, 32 to connect to the base station. The connection request will include information identifying the electronic communications device 10, for example the IMSI (International Mobile Subscriber Identity) of the electronic communications device 10.

As the location of the electronic communications device 10 changes, the electronic communications device 10 monitors the signal strength from the base stations 31, 32 that are within the communication range of the electronic communications device 10, in order to maintain optimum communication with the cellular network. Where the electronic communications device 10 has established communication with a first base station 31 and subsequently detects that the signal strength is higher from a second base station 32 than that from the first base station 31, the electronic communications device 10 will connect to the second base station 32 and cease communication with the first base station 31. This is known as “handover” or “handoff” and maintains continuous communication between the electronic communications device 10 and the cellular network as the location of the electronic communications device 10 changes.

The environment shown in FIG. 1 further includes an IMSI catcher 20 (also called a Stingray device, a false base station or a false cell tower). The IMSI catcher 20 imitates the legitimate base stations 31, 32 with the aim of receiving a connection request from the electronic communications device 10, including the identifying information of the electronic communications device 10. In this way, the IMSI catcher 20 can determine that a particular electronic communications device 10 is in the vicinity of the IMSI catcher 20. This information has value in the context of espionage and other nefarious activities. For example, the transmitted information may be used for identification or tracking of electronic communications devices associated with individuals.

If the IMSI catcher 20 is able to connect successfully to the electronic communications device 10, it may be able to act as a “man-in-the-middle”, intercepting communications from the electronic communications device 10 before forwarding those communications on to the cellular network. In this way the IMSI catcher 20 can not only obtain identifying information from the electronic communications device 10, but also spy on the content of communications from the electronic communications device 10.

In order for the electronic communications device 10 to be protected from the potentially harmful activities of the IMSI catcher 20, the electronic communications device 10 must be able to distinguish between the IMSI catcher 20 and a legitimate base station 31, 32. The methods used by the electronic communications device 10 to distinguish between the IMSI catcher 20 and a legitimate base station 31, 32, in accordance with the present disclosure, will be described below.

A first characteristic of the IMSI catcher 20 that can be used by the electronic communications device 10 to identify that the IMSI catcher 20 is not a legitimate base station 31, 32 is the geographical location of the IMSI catcher 20. The electronic communications device 10 can request location information from the IMSI catcher 20. The IMSI catcher 20 may fail to provide location information. The failure to provide location information is an indication that the IMSI catcher 20 is not a legitimate base station 31, 32. A lack of location information (positioning data) from a base station may be used to identify the base station as an IMSI catcher 20. Typically, genuine cell towers are devised to assist a mobile phone (or other electronic communications device) in locating itself. To aid in this, the phone does not even need to be a subscriber to the operator of the cell tower (base station), as the phone can simply send a ‘roaming’ signal to access that information. IMSI-catchers are not normally equipped to give such signals, and the lack of response to such location requests is a strong indicator of a false base station.

Genuine base stations (cell towers) are fixed installations, and once a geographical location for the cell tower is established, this can be used as a baseline to discriminate cell towers that emulate a nearby cell tower. In order to appear accessible to the electronic communications device 10 the IMSI catcher may provide identifying information to the electronic communications device 10 and the identifying information may correspond to the legitimate identity of a real base station. In this case, the electronic communications device 10 may obtain location information for the IMSI catcher 20 from a third party source. For example, the electronic communications device 10 may access a database of locations for base stations and look up the identifying information received from the IMSI catcher 20 in the database to obtain an expected location for the IMSI catcher 20. The database may be stored on the electronic communications device 10 or may be a remotely accessed database. The electronic communications device 10 can then compare the expected location of the IMSI catcher 20 to the current location of the electronic communications device 10, determined for example by Global Positioning System (GPS) information. If the expected location of the IMSI catcher 20 is more than a predetermined distance from the current location of the electronic communications device 10, the electronic communications device 10 can determine that the identifying information provided by the IMSI catcher 20 is suspicious, because a base station with that identifying information should not be in the vicinity of the electronic communications device 10.

The geographical location of the IMSI catcher 20 may be determined by the electronic communication device 10, for example by ping time measurements. Location information for a given base station (or IMSI catcher 20) may be determined by accumulating measurements from multiple electronic communication devices 10, for example by triangulation, in order to determine more accurately the location of the IMSI catcher 20 (or base station). The location information for a given base station determined by multiple electronic communications devices 10 may be shared between the electronic communications devices 10 using the cellular network, for example by storing the determined location information together with the identifying information for each base station in a central database.

Alternatively, the geographical location of the IMSI catcher 20 may be determined based on a path loss and a wavelength or frequency of a carrier signal received from the IMSI catcher 20. In particular, the equation below can be used:

$$d = \frac{λ {e}^{\frac{1}{20} L ( lo g ( 2 ) + lo g ( 5 ) )}}{4 π}$$

where λ=wavelength, L=path loss in decibels and d=distance between the IMSI catcher 20 and the electronic communications device 10. Thus, the geographical location can be a radius along which the IMSI catcher 20 is located, or the geographical location can be determined based on measurements from multiple locations of the electronic communications device 10 or based on measurements from multiple electronic communication devices located in different locations.

In another alternative, the distance between the IMSI catcher 20 and the electronic communications device 10 may be determined based on the path loss exponent, the path loss in decibels and a constant to account for system losses. In particular, the equation below can be used:

$$d = {10}^{\frac{L}{10 n} - \frac{C}{10 n}}$$

where L=path loss in decibels, n=path loss exponent, C is a constant to account for system losses and d is the distance between the IMSI catcher 20 and the electronic communications device 10.

The distance calculated between the IMSI catcher 20 and the electronic communications device 10 may be used to calculate the transmission power of the IMSI catcher 20.

The identifying information provided by the IMSI catcher 20 may, itself, be used as a characteristic that the electronic communications device 10 can use to distinguish between the IMSI catcher 20 and a legitimate base station 31, 32. For example, the electronic communications device 10 may compare the received identifying information to a list of identifying information for base stations that are known to be legitimate. The list may be stored locally on the electronic communications device 10 or may be accessed remotely. The list of legitimate base stations may be updated as the electronic communications device 10 changes location so that the list corresponds to the identities of the legitimate base stations in the expected vicinity of the electronic communications device 10. Alternatively, the list of legitimate base stations may correspond to the identities of all the legitimate base stations with which the electronic communications device 10 is expected to connect. The list of legitimate base stations may be updated by electronic communications devices 10 in the cellular network that have successfully determined a base station 31, 32 to be legitimate. Thus, it is possible to build up the list of legitimate base stations using applications running on multiple electronic communications devices 10 that constantly monitor base stations to which the electronic communications devices 10 are connected. When a base station is observed to work in compliance with the expected behaviour of a cell tower for a given period of monitoring time, the base station details can be entered onto the list (the “whitelist”). An alternative way to build up the database of legitimate base stations is to utilise information from third party lists of genuine cell towers collected from parties like Google, Apple or others, or lists provided by the Telco itself.

A further characteristic that the electronic communications device 10 can use to distinguish between the IMSI catcher 20 and a legitimate base station 31, 32 is the signal strength from the IMSI catcher 20. Cell towers (base stations) are typically constrained as to the maximum output power permissible by local laws. IMSI catchers 20 often radiate higher signal strengths than legitimate base stations 31, 32 in order that they preferentially receive connection requests from electronic communications devices 10. False cell towers (IMSI-catchers) are often designed to transmit with a power far exceeding the legal limits for cell tower transmitters. This is to be sure that the false cell tower poses as the strongest and therefore most attractive cell tower in an area, which increases the chances of a target electronic communications device attempting to connect to the cell tower. A further benefit to the false cell tower of using excessive signal strength is to cover a larger geographical area than would typically be possible from a genuine cell tower. If the electronic communications device 10 identifies a signal level that is suspiciously strong (regardless of the distance from the cell tower), this will be a clear indication that the cell tower may be a false cell tower (or IMSI-catcher). Thus, if the signal strength from the IMSI catcher 20 is above a predetermined level, the electronic communications device 10 may identify the IMSI catcher 20 as a potentially suspicious base station.

Another potential identifying characteristic of a false cell tower (IMSI catcher) is the emergence of a new and strong cell tower within a geographical area. If a neighbouring cell to the current cell tower connected to the electronic communications device 10 suddenly appears having a very strong signal strength, this may strongly indicate that the neighbouring cell tower is an IMSI catcher 20 which has just been activated. For a genuine cell tower, one would expect the signal strength of the neighbouring cell to increase gradually as the electronic communications device moves into the area of coverage of the neighbouring cell. Thus, the electronic communication device 10 may identify an IMSI catcher 20 by a step change in signal strength from a base station, i.e. the IMSI catcher 20. The step change may be identified as an increase from zero detected signal strength to a signal strength above a predetermined level over a predetermined (short) period of time. The step change may be identified as suspicious when there is no substantial change in the location of the electronic communications device 10 over the predetermined period of time.

The signal strength can be used in combination with the expected location of the IMSI catcher 20. The electronic communications device 10 can calculate an expected signal strength for the IMSI catcher 20 based on the current location of the electronic communications device 10, the expected location of the IMSI catcher 20 and an expected radiating signal strength of the IMSI catcher 20. If the signal strength measured by the electronic communications device 10 from the IMSI catcher 20 is higher than the calculated signal strength, the electronic communications device 10 may identify the IMSI catcher 20 as a potentially suspicious base station, because the IMSI catcher 20 is either radiating at too high a level or cannot be in the expected location.

The expected signal strength of the base station (or IMSI catcher 20) can be calculated based on previously measured signal strengths for the identified base station measured by other electronic communications devices 10 at known locations. If the signal strength differs significantly from the expected signal strength, this may indicate a false cell tower, i.e. an IMSI catcher 20. Signal strength maps can also be built up over time using many subscribers of the same service to collect the data. This will provide a more accurate expected signal due to obstacles such as hills and buildings which can produce signal black-spots.

A further characteristic of the communication with a base station that can be used to identify an IMSI catcher is the communications services available to the electronic communications device from the base station. For example, a potential indication of a false cell tower is a lack of an Internet connection from the false base station. Most IMSI-catchers connect to the devices for only a short period of time and have no real Internet connection. The lack of such a connection is extremely suspicious, especially combined with a short connection to the device. A Telco legitimate cell tower is highly unlikely to instruct a device to connect to a cell tower without an Internet connection in preference to another cell tower having an Internet connection.

Similarly, a potential indication of a false cell tower is a lack of a DNS (Domain Name System) service. In some cases, IMSI-catchers will offer a false DNS service with the same IP address as the Telco's standard DNS. The IMSI-catcher will use a firewall in the IMSI-catcher to achieve this. The purpose of this is to monitor the Internet traffic, and also to falsify the standard proxy server of the Telco. In this mode the electronic communications device 10 will operate normally, but all traffic will be routed through a third party service and monitored. In this situation, an encrypted signature can be added to the Telco DNS and proxy server. By checking both for the presence of a DNS service, and if the DNS service is present, checking for the authenticity and validity of an encrypted signature from the DNS service and/or the proxy server, it is possible to detect if there is an IMSI-catcher masquerading as the cell tower, and potentially even intercepting the IP-based traffic.

Another potential indication of a false cell tower is a lack of a ‘keep alive’ signal from within the Telco's network. For this to indicate a false cell tower, all genuine cell towers in the Telco's network must transmit a ‘keep alive’ signal at expected times, or there is a server within the Telco network that is only available as long as it is connected to a legitimate cell tower. In some embodiments, this may also be combined with a measurement of the number of ‘hops’, i.e. the number of device-to-device steps for data communications from the electronic communications device 10 to a known destination device in the cellular (or associated fixed) network. Where an application running on the electronic communications device has knowledge of (or can calculate) the correct number of hops for a particular communication path, if an IMSI-catcher is intercepting the traffic there will be one too many, and this will indicate the presence of an IMSI-catcher 20. Thus, by comparing the route for internet protocol traffic from the electronic communications device 10 to a known destination IP address to an expected route, the electronic communications device 10 can determine that an IMSI catcher is intercepting traffic.

A further characteristic of the communication with a base station that can be used to identify an IMSI catcher is a request from the base station (or IMSI catcher) to the electronic communications device to change the mode of communication with the base station. For example a request from the IMSI catcher to use a lower speed communications protocol when a higher speed connection is available, either from the IMSI catcher itself, or from one or more genuine cell towers in the vicinity of the electronic communications device. Many IMSI-catchers ask the target electronic communications device to change to a lower connection speed, such as EDGE, which is an older standard with less security. If a cell tower asks for this when the initial connection is at a higher level, such as 3G (e.g. HSDPS) or 4G (e.g. LTE), this can be a clear indication of a false cell tower. Also, if neighbouring and available cells provided by other cell towers offer higher speed this is also suspicious and will be a clear indication that the current cell tower may be a false cell tower or an IMSI-catcher.

Another potential indication of a false cell tower is a request to turn off the use of a Temporary Mobile Subscriber Identity (TMSI). A TMSI is a virtual IMSI number that changes often. The TMSI is a functionality the Telco applies to hide the real IMSI number in their network to make it more difficult to track an electronic communications device from inside the Telco network. The Telco can request the device to turn off this functionality, but in real life scenarios this is an extremely rare occurrence. To receive a request for TMSI to be turned off is therefore a very good indicator that the electronic communications device is under attack from an IMSI-catcher.

Another potential indication of a false cell tower is a request to turn off encryption. This is often combined with the request for a lower speed connection using older security standards, such as EDGE, and, if obeyed, can provide easy access to the phone's data. To receive this kind of request is a very good indicator of an IMSI-catcher as it is highly improbable that a Telco would ever request that.

The above characteristics and indications of an IMSI catcher can be used in combination by an electronic communications device 10 to determine the legitimacy of a base station in a cellular network.

In the event that the electronic communications device 10 identifies an IMSI catcher 20 within its communication range, the electronic communications device 10 may be programmed to take one or more actions.

A first possible action is for the electronic communications device 10 to notify the user of the electronic communications device 10. The user can be notified by an audible alarm. In an example, the user can be notified by an on-screen notification displayed on a screen of the electronic communications device. The user should generally be notified of the attack and advised to take precautions. These precautions can include instructing the user to move out of the area, and so away from the IMSI-catcher.

The electronic communications device 10 may alternatively or in addition notify the identification of the IMSI catcher 20 to other electronic communication devices in the cellular network. Such notifications may be communicated via a communication channel other than the cellular network. For example, the electronic communications device 10 may use a local wireless network, such as a WiFi network, to communicate with other electronic communication devices 10. Alternatively or in addition, the electronic communication device 10 may notify a central server of the identification of the IMSI catcher 20. Again, the electronic communications device 10 may use a local wireless network, such as a WiFi network, to communicate with the central server.

If an IMSI-catcher is detected, it can be desirable to try to establish the actual geographic location of the IMSI-catcher 20. The IMSI catcher 20 can be located, for example, by ping time measurements, signal strength measurements or other means. Where the electronic communications device 10 notifies other electronic communications devices 10 of the identification of the IMSI catcher 20, the other electronic communications devices 10 may also participate in locating the IMSI catcher 20. Using multiple electronic communications devices 10 in the vicinity of the first electronic communications device 10, it is possible to triangulate a position for the IMSI catcher 20.

It will be understood therefore that in some embodiments, an electronic communications device 10 may simply receive a notification of the presence of an IMSI catcher 20, without itself having made the determination that the relevant base station is actually an IMSI catcher. The determination may be received from a further electronic device in wireless communication with the electronic communications device.

A central server receiving a notification of the detection of an IMSI catcher 20 from an electronic communications device 10 may update a central database of illegitimate base stations, for example by removing the identified base station from a white list or by adding the identified base station to a “red list” of known IMSI catchers. Thus, the electronic communications device 10 may send a report of the attack or attempted attack to the central server for processing, where a database of both legitimate base stations as well as attacks can be built up. It will be appreciated that the report may need to be sent at a later time after a safe connection to the central server can be established. The database system will in case of an attack analyse the severity of the alert received and may alert users in the vicinity of the danger as well as informing users of suggested actions (or potentially automatically taking suggested actions on the electronic communications devices in the vicinity of the danger). This can be built out to a system with analytical capabilities or even artificial intelligence to sort, categorize and create threat maps and other useful information for users and third party organisations.

The electronic communications device 10 may update a local list of known IMSI catchers, the local list being stored on the electronic communications device 10. Such an exclusion list is a “red list” of base stations to which the electronic communications device 10 is unauthorised to connect. In this way, it is possible to avoid the electronic communications device 10 ever connecting to a base station that has been previously determined by the electronic communications device 10 to be an IMSI catcher. The user may then be informed of the action taken and that an attempt to attack has been conducted. The electronic communications device 10 may update the local “red list” in response to a notification received from another electronic communications device 10 or from the central server without itself detecting the IMSI catcher 20.

In some cases, the electronic communications device 10 may be programmed automatically to disable the radio/mobile telecommunication unit of the electronic communications device 10 in order to prevent further communication with the IMSI catcher 20. In other words, the electronic communications device 10 can be automatically put into flight mode as one example of a way to protect the device from further harm. Put another way, the electronic communications device 10 can be put into a controlled communication mode wherein, in the controlled communication mode, mobile telecommunication between the electronic communications device and further electronic devices is not possible. Simultaneously, or a short time thereafter, the electronic communications device 10 may alert the user of the attack or attempted attack. In the controlled communications mode the electronic communications device 10 may retain the ability to communicate via other communications channels, such as WiFi, in order that the electronic communications device 10 can notify the central server and/or other electronic communications devices 10, if a suitable communications channel is available.

It will be understood that one or more of the actions discussed above can be implemented and operated in any combination, including in isolation, unless the action explicitly depends on the completion of a further action as described herein.

It will be appreciated that whilst the preceding disclosure relates to IMSI-catchers, it can be extended to apply to any mobile transceiver which is an unauthorised mobile transceiver. An unauthorised mobile transceiver can be any mobile transceiver unauthorised by the telecommunications company for use in providing mobile service to electronic communications devices of subscribers of the telecommunications company.

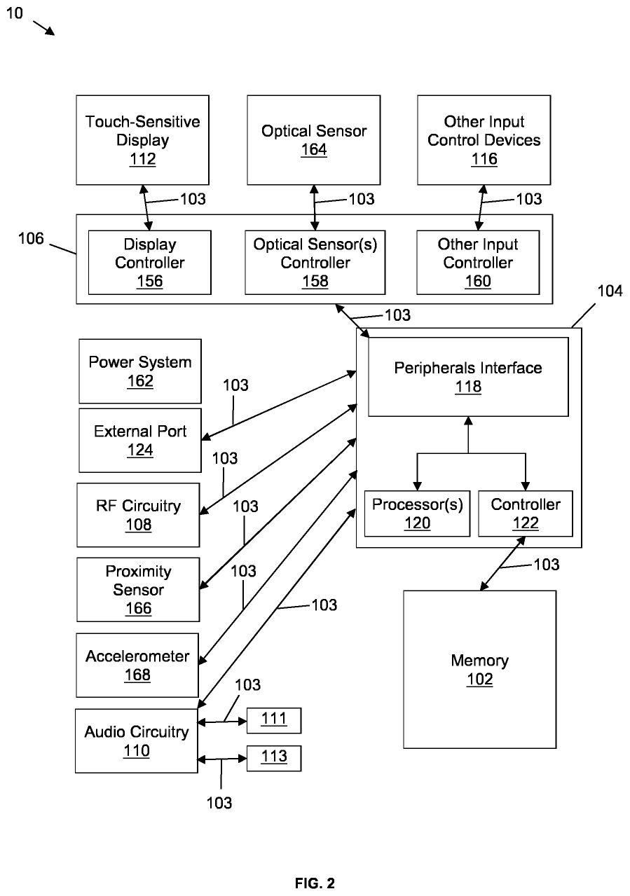

In embodiments, the electronic communications device 10 is a mobile device, for example a tablet computer, mobile phone or in particular a smartphone. Attention is now directed towards embodiments of electronic communications devices 10. FIG. 2 shows a block diagram illustrating an electronic communications device 10 with a touch-sensitive display 112 which can be used to carry out the methods of the present disclosure. The touch-sensitive display 112 is sometimes called a “touch screen” for convenience, and may also be known as or called a touch-sensitive display system. The device 10 may include a memory 102 (which may include one or more computer readable storage mediums), a memory controller 122, one or more processing units (CPU's) 120, a peripherals interface 118, RF circuitry 108, audio circuitry 110, a speaker 111, a microphone 113, an input/output (I/O) subsystem 106, other input or control devices 116, and an external port 124. The device 10 may include one or more optical sensors 164. These components may communicate over one or more communication buses or signal lines 103.

It should be appreciated that the device 10 is only one example of an electronic communications device 10, and that the device 10 may have more or fewer components than shown, may combine two or more components, or may have a different configuration or arrangement of the components. The various components shown in FIG. 2 may be implemented in hardware, software or a combination of both hardware and software, including one or more signal processing and/or application specific integrated circuits.

Memory 102 may include high-speed random access memory and may also include non-volatile memory, such as one or more magnetic disk storage devices, flash memory devices, or other non-volatile solid-state memory devices. Access to memory 102 by other components of the device 10, such as the CPU 120 and the peripherals interface 118, may be controlled by the memory controller 122.

The peripherals interface 118 couples the input and output peripherals of the device to the CPU 120 and memory 102. The one or more processors 120 run or execute various software programs and/or sets of instructions stored in memory 102 to perform various functions for the device 10 and to process data.

In some embodiments, the peripherals interface 118, the CPU 120, and the memory controller 122 may be implemented on a single chip, such as a chip 104. In some other embodiments, they may be implemented on separate chips.

The RF (radio frequency) circuitry 108 receives and sends RF signals, also called electromagnetic signals. The RF circuitry 108 converts electrical signals to/from electromagnetic signals and communicates with communications networks and other communications devices via the electromagnetic signals. The RF circuitry 108 may include well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. The RF circuitry 108 may communicate with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The wireless communication may use any of a plurality of communications standards, protocols and technologies, including but not limited to Global System for Mobile Communications (GSM), Enhanced Data GSM Environment (EDGE), high-speed downlink packet access (HSDPA), Long Term Evolution (LTE), wideband code division multiple access (W-CDMA), code division multiple access (CDMA), time division multiple access (TDMA), Bluetooth, Bluetooth Low Energy, Wireless Fidelity (Wi-Fi) (e.g., IEEE 802.11a, IEEE 802.11b, IEEE 802.1g, IEEE 802.11n, IEEE802.11ac and/or IEEE 802.1ad), voice over Internet Protocol (Vol P), Wi-MAX, a protocol for email (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), and/or Instant Messaging and Presence Service (IMPS)), and/or Short Message Service (SMS)), or any other suitable communication protocol, including communication protocols not yet developed as of the filing date of this document.

The audio circuitry 110, the speaker 111, and the microphone 113 provide an audio interface between a user and the device 10. The audio circuitry 110 receives audio data from the peripherals interface 118, converts the audio data to an electrical signal, and transmits the electrical signal to the speaker 111. The speaker 111 converts the electrical signal to human-audible sound waves. The audio circuitry 110 also receives electrical signals converted by the microphone 113 from sound waves. The audio circuitry 110 converts the electrical signal to audio data and transmits the audio data to the peripherals interface 118 for processing. Audio data may be retrieved from and/or transmitted to memory 102 and/or the RF circuitry 108 by the peripherals interface 118. In some embodiments, the audio circuitry 110 also includes a headset jack. The headset jack provides an interface between the audio circuitry 110 and removable audio input/output peripherals, such as output-only headphones or a headset with both output (e.g., a headphone for one or both ears) and input (e.g., a microphone).

The I/O subsystem 106 couples input/output peripherals on the device 10, such as the touch screen 112 and other input/control devices 116, to the peripherals interface 118. The I/O subsystem 106 may include a display controller 156 and one or more input controllers 160 for other input or control devices. The one or more input controllers 160 receive/send electrical signals from/to other input or control devices 116. The other input/control devices 116 may include physical buttons (e.g., push buttons, rocker buttons, etc.), dials, slider switches, joysticks, click wheels, and so forth. In some alternate embodiments, input controller(s) 160 may be coupled to any (or none) of the following: a keyboard, infrared port, USB port, and a pointer device such as a mouse. The one or more buttons may include an up/down button for volume control of the speaker 111 and/or the microphone 113. The one or more buttons may include a push button. A quick press of the push button may disengage a lock of the touch screen 112 or begin a process that uses gestures on the touch screen to unlock the device. A longer press of the push button may turn power to the device 10 on or off. The user may be able to customize a functionality of one or more of the buttons. The touch screen 112 is used to implement virtual or soft buttons and one or more soft keyboards.

The touch-sensitive touch screen 112 provides an input interface and an output interface between the device and a user. The display controller 156 receives and/or sends electrical signals from/to the touch screen 112. The touch screen 112 displays visual output to the user. The visual output may include graphics, text, icons, video, and any combination thereof (collectively termed “graphics”). In some embodiments, some or all of the visual output may correspond to user-interface objects, further details of which are described below.

A touch screen 112 has a touch-sensitive surface, sensor or set of sensors that accepts input from the user based on haptic and/or tactile contact. The touch screen 112 and the display controller 156 (along with any associated modules and/or sets of instructions in memory 102) detect contact (and any movement or breaking of the contact) on the touch screen 112 and converts the detected contact into interaction with user-interface objects (e.g., one or more soft keys, icons, web pages or images) that are displayed on the touch screen. In an exemplary embodiment, a point of contact between a touch screen 112 and the user corresponds to a finger of the user.

The touch screen 112 may use LCD (liquid crystal display) technology, or LPD (light emitting polymer display) technology, although other display technologies may be used in other embodiments. The touch screen 112 and the display controller 156 may detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with a touch screen 112.

The touch screen 112 may have a resolution in excess of 100 ppi. The user may make contact with the touch screen 112 using any suitable object or appendage, such as a stylus, a finger, and so forth. In some embodiments, the user interface is designed to work primarily with finger-based contacts and gestures, which are much less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, the device 10 may include a touchpad (not shown) for activating or deactivating particular functions. In some embodiments, the touchpad is a touch-sensitive area of the device that, unlike the touch screen, does not display visual output. The touchpad may be a touch-sensitive surface that is separate from the touch screen 112 or an extension of the touch-sensitive surface formed by the touch screen.

The device 10 also includes a power system 162 for powering the various components. The power system 162 may include a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

The device 10 may also include one or more optical sensors 164. FIG. 2 shows an optical sensor coupled to an optical sensor controller 158 in I/O subsystem 106. The optical sensor 164 may include charge-coupled device (CCD) or complementary metal-oxide semiconductor (CMOS) phototransistors. The optical sensor 164 receives light from the environment, projected through one or more lens, and converts the light to data representing an image. In conjunction with an imaging module 143 (also called a camera module), the optical sensor 164 may capture still images or video. In some embodiments, an optical sensor is located on the back of the device 10, opposite the touch screen display 112 on the front of the device, so that the touch screen display may be used as a viewfinder for either still and/or video image acquisition. In some embodiments, an optical sensor is located on the front of the device so that the user's image may be obtained for videoconferencing while the user views the other video conference participants on the touch screen display. In some embodiments, the position of the optical sensor 164 can be changed by the user (e.g., by rotating the lens and the sensor in the device housing) so that a single optical sensor 164 may be used along with the touch screen display for both video conferencing and still and/or video image acquisition.

The device 10 may also include one or more proximity sensors 166. FIG. 2 shows a proximity sensor 166 coupled to the peripherals interface 118. Alternately, the proximity sensor 166 may be coupled to an input controller 160 in the I/O subsystem 106. In some embodiments, the proximity sensor turns off and disables the touch screen 112 when the multifunction device is placed near the user's ear (e.g., when the user is making a phone call). In some embodiments, the proximity sensor keeps the screen off when the device is in the user's pocket, purse, or other dark area to prevent unnecessary battery drainage when the device is a locked state.

The device 10 may also include one or more accelerometers 168. FIG. 2 shows an accelerometer 168 coupled to the peripherals interface 118. Alternately, the accelerometer 168 may be coupled to an input controller 160 in the I/O subsystem 106. In some embodiments, information is displayed on the touch screen display in a portrait view or a landscape view based on an analysis of data received from the one or more accelerometers.

The external port 124 (e.g., Universal Serial Bus (USB), FIREWIRE, Lightning, 30-pin connector, etc.) is adapted for coupling directly to other devices or indirectly over a network (e.g., the Internet, wireless LAN, etc.).

Examples of applications that may be stored in memory 102 include JAVA-enabled applications, encryption, digital rights management, online gaming applications and security applications. The memory 102 may also store an application for detecting spoofed base transceiver stations in wireless communication with the device 10.

Furthermore, memory 102 may store additional modules and data structures not described above.

In some embodiments, the device 10 is a device where operation of a predefined set of functions on the device is performed exclusively through a touch screen 112 and/or a touchpad. By using a touch screen and/or a touchpad as the primary input/control device for operation of the device 10, the number of physical input/control devices (such as push buttons, dials, and the like) on the device 10 may be reduced.

The predefined set of functions that may be performed exclusively through a touch screen and/or a touchpad include navigation between user interfaces. In some embodiments, the touchpad, when touched by the user, navigates the device 10 to a main, home, or root menu from any user interface that may be displayed on the device 10. In such embodiments, the touchpad may be referred to as a “menu button.” In some other embodiments, the menu button may be a physical push button or other physical input/control device instead of a touchpad.

The electronic device 10 is suitable for being used to detect a spoofed base transceiver station as described previously.

Although the disclosure has described an electronic communications device 10 which is typically a mobile electronic communications device, it will be appreciated that the methods may equally be applied by a fixed electronic device configured to emulate an electronic communications device 10, whereby to provide a fixed detector of false base stations, for example to identify IMSI catchers in range of a fixed geographical area, such as a building, compound, or town.

Throughout the description, the terms “cell tower” and “base station” are used interchangeably and it should be understood that the disclosure extends to the use of any of these terms in place of the other unless the context of the disclosure expressly prevents this.

Throughout the description and claims of this specification, the words “comprise” and “contain” and variations of them mean “including but not limited to”, and they are not intended to (and do not) exclude other components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

1. A method of determining the legitimacy of a base station in a cellular telecommunications network by an electronic communication device capable of connection to the cellular telecommunications network, the method comprising:
the electronic communication device determining an expected signal strength for transmissions from the base station based at least on an expected geographical location of the base station relative to a current geographical location of the electronic communication device;
the electronic communication device measuring an actual signal strength of transmissions from the base station;
the electronic communication device comparing the actual signal strength to the expected signal strength; and
the electronic communication device determining that the base station is illegitimate if the actual signal strength exceeds the expected signal strength by at least a predetermined amount.

2. The method as claimed in claim 1, wherein the electronic communication device receives identification information from the base station and the electronic communication retrieves data in respect of the base station from a database using the identification information.

3. The method as claimed in claim 2, wherein the electronic communication device determines that the base station is illegitimate if the retrieved data indicates that the base station is illegitimate.

4. The method as claimed in claim 2, wherein the electronic communication device determines that the base station is legitimate if the retrieved data indicates that the base station is legitimate.

5. The method as claimed in claim 2, wherein the retrieved data includes the expected signal strength for transmissions from the base station at the current geographical location of the electronic communication device.

6. The method as claimed in claim 2, wherein the retrieved data includes the expected geographical location of the base station.

7. The method as claimed in claim 1, wherein the electronic communication device requests the expected geographical location from the base station.

8. The method as claimed in claim 7, the electronic communication device determines that the base station is illegitimate if the base station does not provide the expected geographical location.

9. The method as claimed in claim 1, wherein the electronic communication device determines the expected geographical location of the base station relative to a current geographical location of the electronic communication device based on ping time measurements of communications between the electronic communication device and the base station.

10. The method as claimed in claim 5, wherein the electronic communication device calculates the expected signal strength based on the current geographical location of the electronic communication device and the expected geographical location of the base station.

11. The method as claimed in claim 5, wherein the electronic communication device determines that the base station is illegitimate if the distance between the current geographical location of the electronic communication device and the expected geographical location of the base station is greater than a predetermined value.

12. The method as claimed in claim 1, wherein the electronic communication device determines that the base station is illegitimate if the actual signal strength exceeds an absolute predetermined value.

13. The method as claimed in claim 1, wherein the electronic communication device determines that the base station is illegitimate if the difference between the actual signal strength and a previous measurement of the actual signal strength, if any, at substantially the same current geographical location of the electronic communication device exceeds a predetermined value.

14. A method of determining the legitimacy of a base station in a cellular telecommunications network by an electronic communication device capable of connection to the cellular telecommunications network, the method comprising:
the electronic communication device determining a distance between an expected geographical location of the base station relative to a current geographical location of the electronic communication device;
the electronic communication device determining that the base station is illegitimate if the distance between the current geographical location of the electronic communication device and the expected geographical location of the base station is greater than a predetermined value.

15. The method as claimed in claim 14, wherein the electronic communication device receives identification information from the base station and the electronic communication retrieves data in respect of the base station from a database using the identification information and the retrieved data includes the expected geographical location of the base station.

16. The method as claimed in claim 14, wherein the electronic communication device requests the expected geographical location from the base station.

17. The method as claimed in claim 16, the electronic communication device determines that the base station is illegitimate if the base station does not provide the expected geographical location.

18. The method as claimed in claim 14, wherein the electronic communication device determines the expected geographical location of the base station relative to a current geographical location of the electronic communication device based on ping time measurements of communications between the electronic communication device and the base station.

19. The method as claimed in claim 14, wherein if the electronic communication device determines that the base station is illegitimate, the electronic communication device sends identifying information relating to the illegitimate base station to at least one further electronic communication device.

20. The method as claimed in claim 19, wherein the electronic communication device sends the identifying information to the further electronic communication device via a communications channel other than the cellular telecommunications network, for example via WiFi.

21. The method as claimed in claim 19, wherein on receipt of the identifying information the further electronic communication device attempts to determine a distance between an actual geographical location of the base station and the current geographical location of the other electronic communication device.

22. The method as claimed in claim 14, wherein if the electronic communication device determines that the base station is illegitimate, the electronic communication attempts to determine a distance between an actual geographical location of the base station and the current geographical location of the other electronic communication device.

23. The method as claimed in claim 21, comprising determining the actual geographical location of the base station on the basis of the distances between the actual geographical location of the base station and the current geographical locations of the electronic communication device and the further electronic communication device.

24. (canceled)

25. (canceled)
